(19) United States
(12) Patent Application Publication
(10) Pub. No.: US 2026/0321167 A1
(43) Pub. Date: Oct. 15, 2026

(54) SYSTEMS AND METHODS FOR COLLAPSIBLE SIGN FRAME WITH BANNER PANEL SIDE FOR LOADING AND LEVELING

(71) Applicant: Glenn Linden, Piedmont, OK (US)

(72) Inventor: Glenn Linden, Piedmont, OK (US)

(21) Appl. No.: 19/039,736

(22) Filed: Jan. 28, 2025

Related U.S. Application Data
(60) Provisional application No. 63/626,036, filed on Jan. 28, 2024.

(51) Int. Cl. G09F 15/00

(52) U.S. Cl. CPC G09F 15/0062; G09F 15/0012

(57) ABSTRACT

Provided is a system and method for a collapsible sign frame with banner panel side loading and leveling. The collapsible sign frames includes an upper crossbeam; a top cap assembled to a top surface of the upper crossbeam; a middle crossbeam; a lower crossbeam; at least one side rail including: at least one cutout; a top surface; a bottom surface assembled to a foot of the lower crossbeam; and hardware used to assemble the lower crossbeam to the at least one side rail; an upright component assembled to the upper crossbeam, the middle crossbeam and the top surface of the at least one side rail; at least one leg assembled through the at least one cutout of the at least one side rail; and at least one leg securing set securing the at least one leg to the at least one side rail.

### CROSS REFERENCE TO RELATED APPLICATIONS

This application claims the benefit of U.S. Provisional Application Ser. No. 63/626,036, filed Jan. 28, 2024, and entitled “Collapsible Sign Frame with Banner Panel Side-Loading and Leveling” the entirety of which is herein incorporated by reference.

### TECHNICAL FIELD

The field of invention generally falls under signs, sign frames, banner panels and similar structures and apparatuses utilized in the advertising and signage industry. Specifically, the present disclosure is related to collapsible sign frames with banner panel sides for loading and leveling, and can be used by businesses, organizations, churches, schools, or any entity that utilizes banners for outdoor advertising purposes. A common problem faced by businesses and organizations that use banners for outdoor advertising is that traditional or conventional banners tend to quickly sag and become unreadable when exposed to wind and temperature changes. This results in wasted time, effort, and money for the entities that choose to display them. Thus, there is a need in the art for a sign frame to address the above-discussed problem of sagging and unreadable banners positioned within them, and also a need for a sign frame to be durable, long-lasting and resilient against adverse weather conditions.

### BACKGROUND

The sign frame of the present disclosure addresses the common problem of sagging and unreadable banners by providing a solution that ensures the longevity, durability and professionalism of a sign frame with a banner panel configured for displaying messages. The presently disclosed sign frame offers benefits for various industries where outdoor signage is utilized as an effective means of communication and advertisement.

Specifically, the sign frame of the present disclosure aims to address the sagging and lack of readability issue by providing a solution that keeps banners looking professional and readable for an extended period of time. By utilizing a sturdy frame made of materials like steel or plastic, the presently disclosed sign frame offers stability and resistance against wind forces that could otherwise cause sagging and distortion of the banners. The design incorporates features such as side-loading capabilities, adjustable legs for leveling, and optional decorative elements like a top cap for added functionality.

By providing a reliable and long-lasting solution, the presently disclosed sign frame enhances the effectiveness and durability of outdoor advertising for businesses, churches, schools, and other organizations. It aims to eliminate the frustration and waste associated with saggy and unreadable banners, providing a more professional and impactful display for the intended message.

More specifically, vinyl banners have been used as temporary signage. Vinyl banners are a relatively inexpensive solution to display messages and advertisements. However, this type of product fails miserably when it must stand up to the elements of the outdoors (alternating winds, changes in temperature, and gravity itself). When harsher weather hits, such as a thunderstorm, these vinyl banners are typically fortunate to survive. The result is saggy, or torn banners that become unreadable, and the branding of the company/business/organization displayed in such a banner has been destroyed. The vast majority of businesses don't realize that mounting a flimsy piece of vinyl with several square feet of surface area, even in moderate winds, is an engineering project.

As a result, the collapsible banner stand of the present disclosure is just that, a pre-engineered banner display. Not only does it solve the problem mentioned above, it also affords the user much more flexibility on the location any user would like to display their message. Temporary signage can now quickly, and professionally, be displayed literally for years on virtually any surface.

Thus, instead of vinyl banners being held in place in large part unsupported, they can be laminated to a sheet of inexpensive material, such as corrugated plastic. This creates what might be called a “banner panel”. From there, these banner panels can be installed in the banner stand in a matter of seconds, by sliding them in the side of the frame. Generally, one would install two banner panels in the given slot of the sign frame, allowing for imagery to be seen from either side of the frame, and be able to switch them out independently, when needed.

A significantly advantageous benefit of this presently disclosed banner stand is that it has the potential to play a large part in the artificial intelligence (AI) era that we're entering. Over the next few years, saggy banners on the side of roads will be unacceptable. One, it will make no sense that we have all this amazing technology around us, but when you drive down a road, saggy banners that look like trash hanging on a couple of sticks is still commonplace. And two, autonomous vehicles will likely need a clear view of not only permanent signage, but also temporary ones as well, to make the decisions they need to make. And speaking of AI, this banner stand makes the use of AI created artwork much more useful and professional looking.

### SUMMARY

Provided is a system and method for a collapsible sign frame with banner panel side loading and leveling. The system for a collapsible sign frame or the collapsible sign frame includes an upper crossbeam; a top cap assembled to a top surface of the upper crossbeam; a middle crossbeam; a lower crossbeam; at least one side rail including: at least one cutout; a top surface; a bottom surface assembled to a foot of the lower crossbeam; and hardware used to assemble the lower crossbeam to the at least one side rail; an upright component assembled to the upper crossbeam, the middle crossbeam and the top surface of the at least one side rail; at least one leg assembled through the at least one cutout of the at least one side rail; and at least one leg securing set securing the at least one leg to the at least one side rail. Moreover, the method for assembling a collapsible sign frame includes: assembling a base assembly comprising a lower crossbeam, at least one side rail, at least one leg and at least one leg securing set; assembling a top assembly comprising at least one upright component, a middle crossbeam, an upper crossbeam, and a top cap; and installing a banner panel.

According to an aspect of the disclosure, various features can be included which are mentioned in the below Specification including the claims. Throughout this disclosure, crossbeam and crossmember are used as synonyms and interchangeably.

Other objects and advantages of the present disclosure will become obvious to the reader and it is intended that these objects and advantages are within the scope of the present disclosure. To the accomplishment of the above and related objects, this disclosure may be embodied in the form illustrated in the accompanying drawings, attention being called to the fact, however, that the drawings are illustrative only, and that changes may be made in the specific construction illustrated and described within the scope of this application.

This has outlined, rather broadly, the features and technical advantages of the present disclosure in order that the detailed description that follows may be better understood. Additional features and advantages of the disclosure will be described below. It should be appreciated by those skilled in the art that this disclosure may be readily utilized as a basis for modifying or designing other structures for carrying out the same purposes of the present disclosure. It should also be realized by those skilled in the art that such equivalent constructions do not depart from the teachings of the disclosure as set forth in the appended claims. The novel features, which are believed to be characteristic of the disclosure, both as to its organization and method of operation, together with further objects and advantages, will be better understood from the following description when considered in connection with the accompanying figures. It is to be expressly understood, however, that each of the figures is provided for the purpose of illustration and description only and is not intended as a definition of the limits of the present disclosure.

### BRIEF DESCRIPTION OF THE DRAWINGS

For a more complete understanding of the present disclosure, reference is now made to the following description taken in conjunction with the accompanying drawings.

FIG. 1A shows a main product configuration according to an aspect of the present disclosure.

FIG. 1B shows a method of assembly of the main product configuration according to an aspect of the present disclosure.

FIG. 2 shows a weldment and an upper crossbeam according to an aspect of the present disclosure.

FIG. 3 shows an upper crossbeam cap according to an aspect of the present disclosure.

FIG. 4 shows a weldment and a middle crossbeam according to an aspect of the present disclosure.

FIG. 5 shows a weldment and a lower crossbeam according to an aspect of the present disclosure.

FIG. 6 shows a weldment and a pedestrian barrier according to an aspect of the present disclosure.

FIG. 7 shows a side rail according to an aspect of the present disclosure.

FIG. 8 shows a weldment and an upright component according to an aspect of the present disclosure.

FIG. 9 shows a weldment and a leg according to an aspect of the present disclosure.

FIG. 10 shows a leg bolt according to an aspect of the present disclosure.

FIG. 11A shows a side rail leg securing assembly according to an aspect of the present disclosure.

FIG. 11B shows another side rail leg securing assembly according to an aspect of the present disclosure.

FIG. 11C shows another side rail leg securing assembly according to an aspect of the present disclosure.

FIG. 11D shows another side rail leg securing assembly according to an aspect of the present disclosure.

FIG. 11E shows a side rail leg securing assembly according to an aspect of the present disclosure.

FIG. 12A shows a lower crossmember assembly/disassembly to the side rail according to an aspect of the present disclosure.

FIG. 12B shows another lower crossmember assembly/disassembly to the side rail according to an aspect of the present disclosure.

FIG. 12C shows another lower crossmember assembly/disassembly to the side rail according to an aspect of the present disclosure.

FIG. 12D shows another lower crossmember assembly/disassembly to the side rail according to an aspect of the present disclosure.

FIG. 13A shows a stage of a top crossbeam being assembled according to an aspect of the present disclosure.

FIG. 13B shows another stage of a top crossbeam being assembled according to an aspect of the present disclosure.

FIG. 13C shows another stage of a top crossbeam being assembled according to an aspect of the present disclosure.

FIG. 14 shows an exemplary sign in use according to an aspect of the present disclosure.

FIG. 15A shows an exemplary sign in use in front of a barn according to an aspect of the present disclosure.

FIG. 15B shows another exemplary sign in use in front of a barn according to an aspect of the present disclosure.

FIG. 15C shows another exemplary sign in use in front of a barn according to an aspect of the present disclosure.

FIG. 16A shows an exemplary sign in use in outdoor environments according to an aspect of the present disclosure.

FIG. 16B shows another exemplary sign in use in outdoor environments according to an aspect of the present disclosure.

FIG. 16C shows another exemplary sign in use in outdoor environments according to an aspect of the present disclosure.

FIG. 16D shows another exemplary sign in use in outdoor environments according to an aspect of the present disclosure.

FIG. 17A shows an exemplary sign in use in outdoor environments with adverse weather conditions according to an aspect of the present disclosure.

FIG. 17B shows another exemplary sign in use in outdoor environments with adverse weather conditions according to an aspect of the present disclosure.

Example embodiments will become more fully understood from the detailed description given herein below and the accompanying drawings, wherein like elements are represented by like reference characters, which are given by way of illustration only and thus are not limitative of the example embodiments herein.

### DETAILED DESCRIPTION

The detailed description set forth below, in connection with the appended drawings, is intended as a description of various configurations and is not intended to represent the only configurations in which the concepts described herein may be practiced. The detailed description includes specific details for the purpose of providing a thorough understanding of the various concepts. It will be apparent to those skilled in the art, however, that these concepts may be practiced without these specific details. In some instances, well-known structures and components are shown in block diagram form in order to avoid obscuring such concepts. As described herein, the use of the term “and/or” is intended to represent an “inclusive OR”, and the use of the term “or” is intended to represent an “exclusive OR”.

The present disclosure is directed to systems and methods for a collapsible sign frame with a banner panel side for loading and leveling. The system for a collapsible sign frame or the collapsible sign frame includes an upper crossbeam; a top cap assembled to a top surface of the upper crossbeam; a middle crossbeam; a lower crossbeam; at least one side rail including: at least one cutout; a top surface; a bottom surface assembled to a foot of the lower crossbeam; and hardware used to assemble the lower crossbeam to the at least one side rail; an upright component assembled to the upper crossbeam, the middle crossbeam and the top surface of the at least one side rail; at least one leg assembled through the at least one cutout of the at least one side rail; and at least one leg securing set securing the at least one leg to the at least one side rail. Moreover, the method for assembling a collapsible sign frame includes: assembling a base assembly comprising a lower crossbeam, at least one side rail, at least one leg and at least one leg securing set; assembling a top assembly comprising at least one upright component, a middle crossbeam, an upper crossbeam, and a top cap; and installing a banner panel.

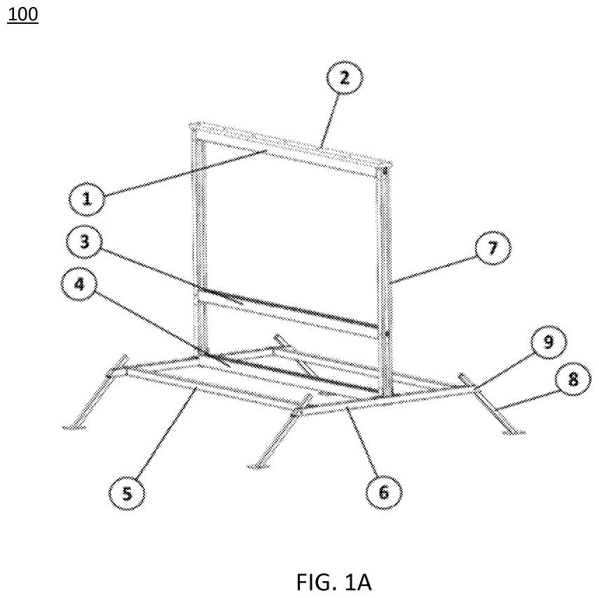

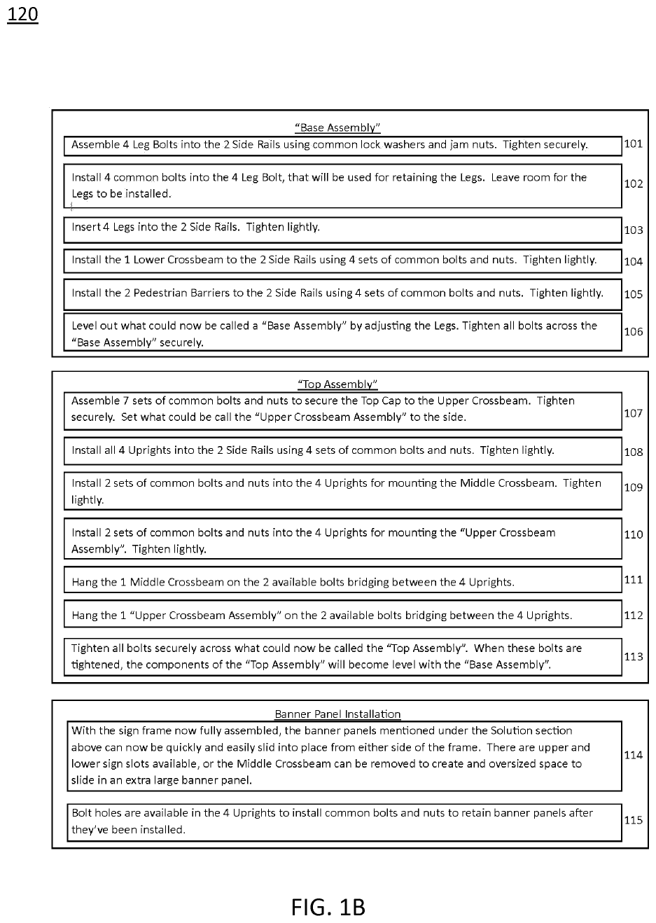

FIG. 1A shows a main product configuration 100 according to an aspect of the present disclosure.

Turning now to FIG. 1A, main product configuration 100 shows a weldment, upper crossbeam 1, a top cap 2, a weldment, middle crossbeam 3, a weldment, lower crossbeam 4, a weldment, pedestrian barrier 5 (which may be an optional component), a side rail 6, a weldment, upright component 7, a weldment, leg 8 and a leg bolt 9.

The materials making up any or all of the aforementioned components may be steel, aluminum, plastic, or similar materials. For the top cap 2, materials that can be used to make it include UV light-resistant materials such as such as high-density polyethylene (HDPE), acrylic, Ultem®, Polyvinylidene fluoride (PVDF), and Polytetrafluoroethylene (PTFE). As a result, solar-powered lights or lights can be easily mounted to the top cap due to being made out of these lightweight materials. For the side rail 6, materials that can be used to make it include steel, aluminum and plastic.

FIG. 1B shows a method of assembly 120 of the main product configuration 100 according to an aspect of the present disclosure. The boxes 101-115 can be executed in any order, and is not limited to the configuration shown in FIG. 1B.

Turning now to FIG. 1B, in the “Base Assembly” module, in box 101, the following action(s) may be performed: assemble four leg bolts 9 into the two side rails 6 using common lock washers and jam nuts. A leg securing set also includes at least one leg bolt, at least one lock washer and at least one jam nut to tighteningly secure the legs to the side rails. Then, tighten securely these components.

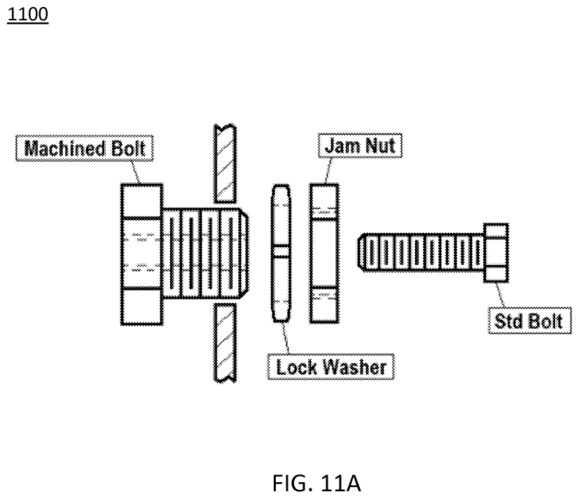

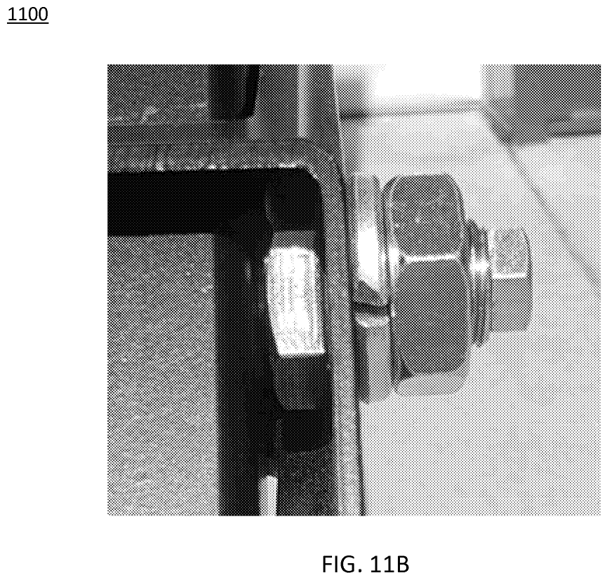

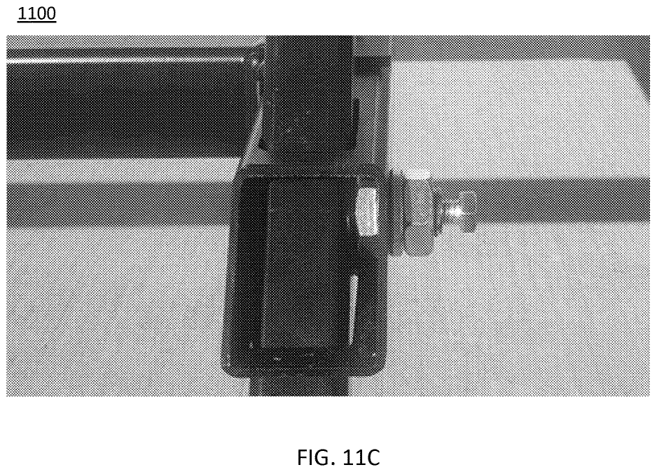

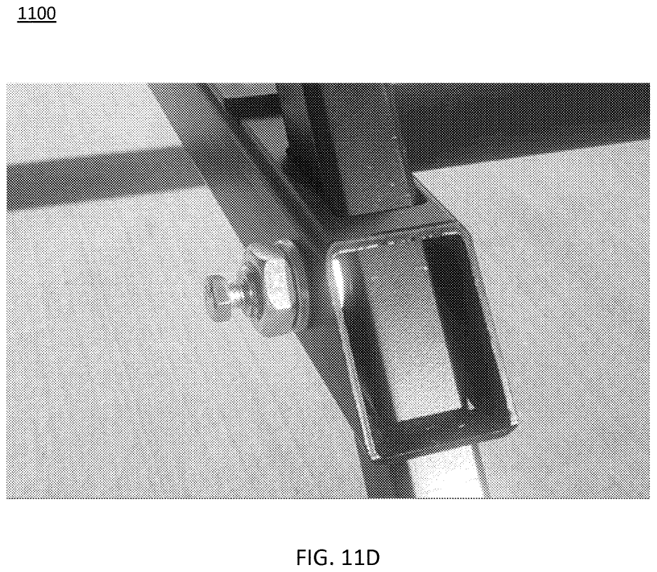

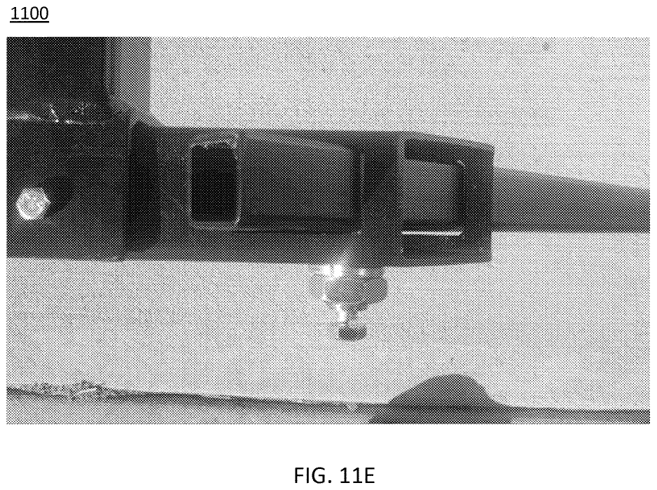

Four legs slide in and out of the ends of the side rails 6, which have cutouts, at a 45-degree angle—specifically, the shafts of the legs are at a 45 degree angle and go through the cutouts—shown in FIGS. 11C-E. Although, this could be a different angle, as well in between the ranges of 20-60 degrees. These legs and the side rails allow for leveling on uneven surfaces and expand the footing of the sign frame as it is assembled higher, enhancing stability. The cutouts can be shaped in configurations including rectangular, square, circular, elliptical, hexagonal, pentagonal, heptagonal, octagonal and any other multi-sided shape.

In box 102, the following action(s) may be performed: install common bolts into the four leg bolts mentioned in box 101, that will be used for retaining the legs 8. Leave room for the legs 8 to be installed as well.

In box 103, the following action(s) may be performed: insert four legs 8 into the two side rails 6. Tighten these components lightly.

In box 104, the following action(s) may be performed: install the one lower crossbeam 4 to the two side rails 6 using four sets of common bolts and nuts. Tighten these components lightly.

In box 105, the following action(s) may be performed: install the two pedestrian barriers 5 to the two side rails 6 using four sets of common bolts and nuts. Tighten these components lightly.

In box 106, the following action(s) may be performed: level out what could now be called a “Base Assembly” by adjusting the legs 8. Tighten all bolts across the “Base Assembly” securely.

In other words, the “Base Assembly” module of boxes 101-106 can also be alternatively summarized as below: wherein assembling the base assembly includes: coupling the at least one leg to the at least one side rail by using the at least one leg securing set, the at least one leg securing set coupled to both the at least one leg and the at least one side rail; tightly securing the at least one leg to the at least one side rail by tightening the at least one leg securing set. Also, wherein the at least one leg securing set includes at least one leg bolt, at least one lock washer and at least one jam nut, and further wherein assembling the base assembly further includes: securing the at least one leg, the at least one side rail, the at least one leg bolt, the at least one lock washer and the at least one jam nut all together; and tightening the at least one leg, the at least one side rail, the at least one leg bolt, the at least one lock washer and the at least one jam nut all together. Also, wherein assembling the base assembly further includes: fitting the at least one leg into at least one cutout of the at least one side rail at an angle; and tightly securing the at least one leg with the at least one leg bolt, the at least one lock washer and the at least one jam nut through the at least one cutout. Also, wherein the angle is selected from the range of 30 to 60 degrees and can be adjusted to provide stability for the collapsible sign frame on an uneven surface. Also, wherein the at least one cutout is shaped in configurations including rectangular, square, circular, elliptical, hexagonal, pentagonal, heptagonal, octagonal and any other multi-sided shape. Also, wherein assembling the base assembly further includes: installing the lower crossbeam to the at least one side rail using a first set of common bolts and nuts; leveling out the lower crossbeam and the at least one side rail by adjusting the at least one leg; and securely tightening the first set of common bolts and nuts across the lower crossbeam and the at least one side rail. Also, wherein assembling the base assembly further includes: installing at least one pedestrian barrier to the at least one side rail using a second set common bolts and nuts; leveling out the lower crossbeam, the at least one side rail and the at least one pedestrian barrier by adjusting the at least one leg; and securely tightening the second set of common bolts and nuts across the lower crossbeam, the at least one side rail and the at least one pedestrian barrier.

In the “Top Assembly” module, we have box 107, where the following action(s) may be performed: assemble multiple (e.g., seven) sets of common bolts and nuts to secure the top cap 2 to the upper crossbeam 1. Tighten these components securely. Set what could be call the “Upper Crossbeam Assembly” to the side.

In box 108, the following action(s) may be performed: install all four upright components 7 into the two side rails 6 using four sets of common bolts and nuts. Tighten these components lightly.

In box 109, the following action(s) may be performed: install two sets of common bolts and nuts into the four upright components 7 for mounting the one middle crossbeam 3. Tighten these components lightly.

In box 110, the following action(s) may be performed: install two sets of common bolts and nuts into the four upright components 7 for mounting the one “Upper Crossbeam Assembly” mentioned in box 107. Tighten these components lightly.

In box 111, the following action(s) may be performed: hang the one middle crossbeam 3 on the two available bolts bridging between the four upright components 7.

In box 112, the following action(s) may be performed: hang the one “Upper Crossbeam Assembly” mentioned in box 107 on the two available bolts bridging between the four upright components 7.

In box 113, the following action(s) may be performed: tighten all bolts securely across what could now be called the “Top Assembly”. When these bolts are tightened, the components of the “Top Assembly” will become level/square with the “Base Assembly”.

In other words, the “Top Assembly” module of boxes 107-113 can also be alternatively summarized as below: coupling the upper crossbeam and the top cap with a first set of common bolts and nuts and securing the upper crossbeam and the top cap with the first set of common bolts and nuts; installing the at least one upright component to the at least one siderail by using a second set of common bolts and nuts and loosely securing the at least one upright component and the at least one siderail with the second set of common bolts and nuts; installing a third set of common bolts and nuts and a fourth set of common bolts and nuts that are coupled to the at least one upright component; hanging the middle crossbeam on the third set of common bolts and nuts; loosely securing the third set of common bolts and nuts on the at least one upright component; hanging the upper crossbeam on the fourth set of common bolts and nuts; loosely securing the fourth set of common bolts and nuts on the at least one upright component; and tightening all the first, second, third and fourth sets of common bolts and nuts to secure the top assembly.

In the “Banner Panel Installation” module, we have box 114, where the following action(s) may be performed: with the sign frame now fully assembled, the banner panels mentioned above can now be quickly and easily slide into place from either side of the frame. There are upper and lower sign slots available, or the middle crossbeam 3 can be removed to create and oversized space to slide in an extra large banner panel. In other words, in box 114, the action can be performed of: sliding a banner panel in between or propped up against the at least one upright component. The scenario of the banner panel being propped up against the at least one upright component occurs when there may only be one upright component.

In box 115, the following action(s) may be performed: bolt holes are available in the four upright components 7 to install common bolts and nuts to retain banner panels after they've been installed. In other words, in box 115, the action can be performed of: installing a first set of common bolts and nuts with the at least one upright component to retain the banner panel that is slid in.

In other words, the “Banner Installation” module of boxes 114-115 can also be alternatively summarized as below: sliding a banner panel in between or propped up against the at least one upright component; and installing a first set of common bolts and nuts with the at least one upright component to retain the banner panel that is slid in. Again, the scenario of the banner panel being propped up against the at least one upright component occurs when there may only be one upright component.

To note is that even though the installation of banner panels is the main focus of the present disclosure, the sign frame could be used to display video boards if/when this technology is available, especially video boards powered/configured by AI technology.

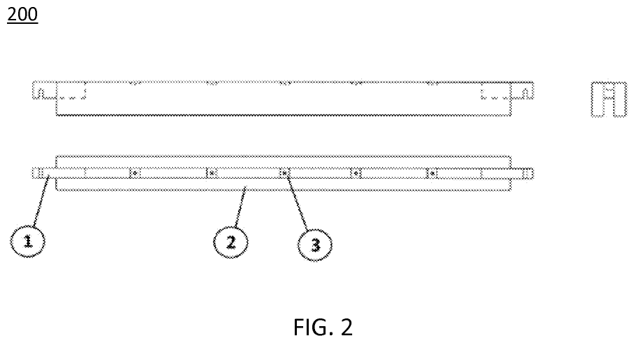

FIG. 2 shows a weldment and an upper crossbeam 200 according to an aspect of the present disclosure. The weldment and upper crossbeam 200 shown in FIG. 2 may be the same or similar component as the weldment and upper crossbeam 1 shown in FIG. 1A and discussed in FIG. 1B.

Turning now to FIG. 2, weldment and upper crossbeam 200 show a semi-rail 1, a wall 2 and a tab 3. The purpose of the weldment and upper crossbeam 200 or weldment, upper crossbeam 200 is to create a top rail that retains the top portions of the upper banner panels.

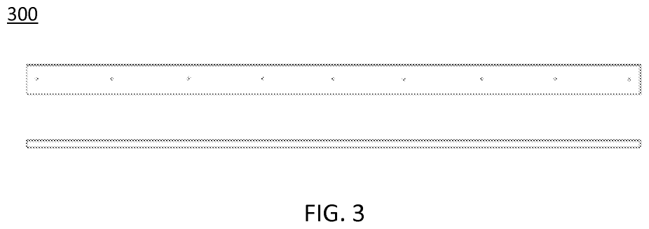

FIG. 3 shows an upper crossbeam cap 300 according to an aspect of the present disclosure. The upper crossbeam cap 300 shown in FIG. 3 may be the same or similar as the upper crossbeam cap or cap 2 shown in FIG. 1A and discussed in FIG. 1B.

Turning now to FIG. 3, upper crossbeam cap 300 may be mounted to the top of the upper crossbeam (200 in FIGS. 2 and 1 in FIG. 1A) to not only add a simple decorative finish, but also to provide a surface for mounting solar lighting.

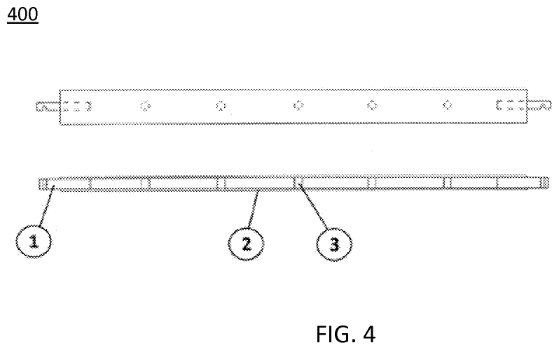

FIG. 4 shows a weldment and a middle crossbeam 400 according to an aspect of the present disclosure. The weldment and middle crossbeam 400 shown in FIG. 4 may be the same or similar as the weldment, middle crossbeam 3 shown in FIG. 1A and discussed in FIG. 1B.

Turning now to FIG. 4, weldment and middle crossbeam 400 or weldment, middle crossbeam 400 includes a semi-rail 1, a wall 2, and a spacer 3. The purpose of the weldment and middle crossbeam 400 is to create a bottom rail for the upper banner panels, retaining their bottom sides. This weldment and middle crossbeam 400 component also serves as the top rail for the lower banner panels, retaining their top sides. It might be noted that the reason why the walls are preferred to be thin is for the possibility of solar lighting to be installed. Doing so allows the light to cascade down onto the lower banner panels, not just the upper panels.

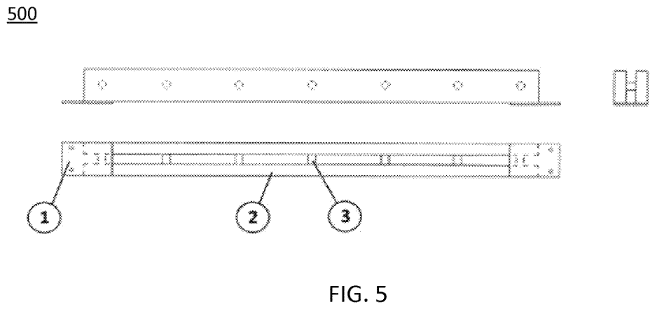

FIG. 5 shows a weldment and a lower crossbeam 500 according to an aspect of the present disclosure. The weldment and lower crossbeam 500 shown in FIG. 5 may be the same or similar as the weldment, lower crossbeam 4 shown in FIG. 1A and discussed in FIG. 1B.

Turning now to FIG. 5, the weldment and lower crossbeam 500 or weldment, lower crossbeam 500 includes a foot 1, a wall 2, and a spacer 3. The lower crossbeam 500 creates a bottom rail, and retains the bottoms of the lower banner panels.

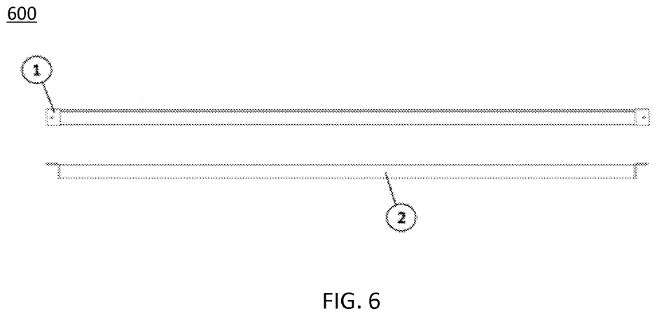

FIG. 6 shows a weldment and a pedestrian barrier 600 according to an aspect of the present disclosure. The weldment and pedestrian barrier 600 shown in FIG. 6 may be the same or similar as the weldment, pedestrian barrier 5 shown in FIG. 1A and discussed in FIG. 1B. This weldment and pedestrian barrier (or weldment, pedestrian barrier) 600 in FIGS. 6 and 5 in FIG. 1A may also be an optional component in the overall main product configuration (e.g., shown as 100 in FIG. 1A).

Turning now to FIG. 6, the weldment and pedestrian banner 600 or weldment, pedestrian banner 600 or simply, pedestrian banner 600 includes a foot 1 and a tube 2. As mentioned above, the pedestrian banner 600 is optional but serves three purposes when installed: (1) if the sign frame is used in a pedestrian setting, the pedestrian barrier 600 helps keep people at a safer distance and protects the safety of pedestrians by preventing them from walking into unsafe components of the collapsible sign frame such as the side rails (or at least one side rail) and the legs (or the at least one leg) that might unexpectedly jut out and cause the pedestrians to trip. This may minimize the frame as a tripping hazard. (2) when the pedestrian barriers 600 are installed, the center of gravity of the overall sign frame apparatus or main product configuration (e.g., 100 as shown in FIG. 1A) becomes somewhat lower. This reduces the risk of tipping of the overall sign frame apparatus/structure or main product configuration in high winds. Even though the overall sign frame structure may be heavy, and can withstand high winds, it should still be anchored down when excessive winds are possible. Finally, (3) without the pedestrian barriers 600 installed, the footing for the sign frame extends from the intersection of where the lower crossbeams and side rails meet. The pedestrian barriers 600 give the sign frame significantly more strength, and the overall sign frame structure or main product configuration becomes more structurally sound when the pedestrian barriers 600 are present.

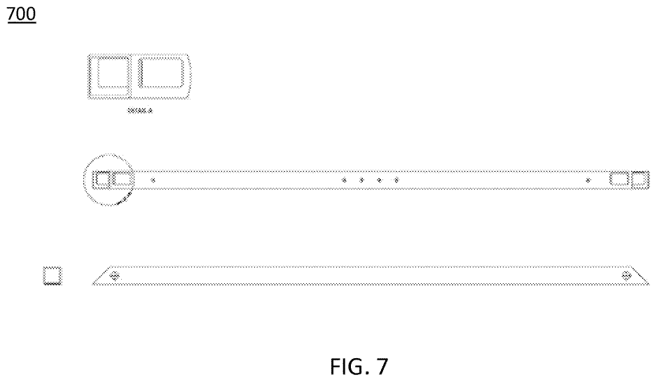

FIG. 7 shows a side rail 700 according to an aspect of the present disclosure. The side rail 700 shown in FIG. 7 may be the same or similar as the side rail 6 shown in FIG. 1A and discussed in FIG. 1B.

Turning now to FIG. 7, the side rail 700 serves as a mount for the legs, pedestrian barriers, lower crossbeam and the upright components (which ultimately hold the middle and upper crossbeams).

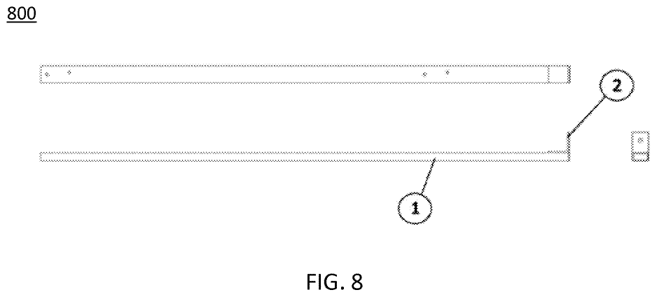

FIG. 8 shows a weldment and an upright component 800 according to an aspect of the present disclosure. The weldment and upright component 800 may be the same or similar as the weldment, upright component 7 shown in FIG. 1A and discussed in FIG. 1B.

Turning now to FIG. 8, the weldment and upright component 800 or weldment, upright component 800 or simply upright component 800 or upright 800 includes a tube 1 and a foot 2 and extends vertically from the side rails when installed in order to mount the middle and upper crossbeams. Bolt holes are also provided to retain the banner panels when installed.

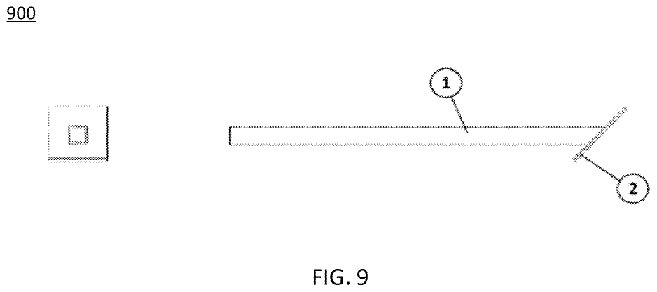

FIG. 9 shows a weldment and a leg 900 according to an aspect of the present disclosure. The weldment and leg 900 may be the same or similar as the weldment, leg 8 shown in FIG. 1A and discussed in FIG. 1B.

Turning now to FIG. 9, the weldment and leg 900 or simply leg 900 includes a tube 1 and a foot 2. The legs 900 can be adjusted independently when installed on the side rails, allowing for the leveling of the sign frame structure in most instances.

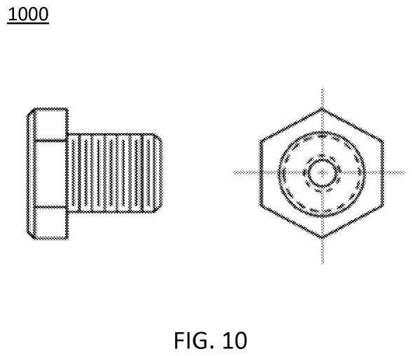

FIG. 10 shows a leg bolt 1000 according to an aspect of the present disclosure. The leg bolt 1000 may be the same or similar as the leg bolt 9 shown in FIG. 1A and discussed in FIG. 1B.

Turning now to FIG. 10, the leg bolt 1000 is machined from a standard stainless steel bolt, with a threaded hole passing through its center, according to an aspect of the present disclosure. This allows for a standard bolt of any material to be installed through it, which will retain the legs 900 without worry of corrosion. In addition to stainless steel, other corrosion-resistant materials e.g., aluminum, titanium and inconel, may be used for the material making up the leg bolt 1000. Other materials for the leg bolt 1000 in addition to stainless steel, aluminum, titanium and Inconel can include galvanized steel, brass, aluminum alloy, duplex stainless steel, and bronze.

FIG. 11A shows a side rail leg securing assembly 1100 according to an aspect of the present disclosure.

FIG. 11B shows another side rail leg securing assembly 1101 according to an aspect of the present disclosure.

FIG. 11C shows another side rail leg securing assembly 1102 according to an aspect of the present disclosure.

FIG. 11D shows another side rail leg securing assembly 1103 according to an aspect of the present disclosure.

FIG. 11E shows a side rail leg securing assembly 1104 according to an aspect of the present disclosure.

Turning now to FIGS. 11A-E, and side rail leg securing assemblies 1100, 1101, 1102, 1103 and 1104, also with reference to the components and reference characters shown in FIG. 1A, for the sign frame 100 to be cost effective, carbon steel will be the ideal material to use. Other materials can include aluminum, copper, stainless steel and other materials. In the area where the leg 8 (FIG. 1A) installs to the side rails 6 (FIG. 1A), there should be threads to use a common bolt to tighten against the tube portion of the leg 8. This allows for there to be infinite adjustment on the tube of the leg 8, so one could get the sign frame truly level. A potential solution would be to drill holes in the tube of the leg 8 and use a pin to secure it. The problem with that is the adjustment becomes incremental, and true leveling would be difficult. Plus, pins are not overly common. If the end user loses a pin, it would be difficult to replace. With common bolts, one can get a replacement easily at the nearest hardware store.

For most, there would be basically three options to have threads available on the side rail 6:
(1) First, machine the threads directly into the material—to begin with, since the material thickness of the side rail 6 tube is relatively thin, one would end up with very few threads available. Also, bare carbon steel is being dealt with, which may be a hard or tough material. After machining, the threads would have to be plated in order to become corrosion resistant. According to one aspect, spot plating may also be applied, but may be tedious and costly/expensive. Therefore, the whole side rail 6 has to be plated just for a little bit of threading at the component's ends, which does not make this option viable.
(2) Second, drill a hole, then weld a nut on top of the hole. This would be the most common approach for most people to take. It is pretty quick, easy, and would be an inexpensive process. However, a carbon steel nut will have plating. When it becomes welded, the plating will burn off. The result are threads that will rust and corrode relatively quickly when out in adverse weather. Hence, the question arises of whether it is possible to weld stainless steel to carbon steel? Yes, but this is very uncommon, and the results are unpredictable. Regardless, the finished side rail 6 is ultimately powder-coated, or painted. Thus, even if this route were taken to weld a stainless steel nut, you'd have to mask it during the process, adding cost. The bottom line is that the final product would look shoddy.
(3) Third, install PEM® (Penn Engineering & Manufacturing Corporation) Nuts or simply PEM® Nuts-this item uses ridges that would bite into the circumference of the drilled hole in the side of the side rail 6. Unfortunately, PEM® Nuts are susceptible to stripping out. If one was to do that with the side rail 6, the whole side rail 6 would have to be replaced. Therefore, this is potentially a very costly method to solve the problem.

Solution: the solution is to use a leg securing set to tighteningly secure the leg with the side rail. A leg securing set also includes at least one leg bolt, at least one lock washer and at least one jam nut to tighteningly secure the legs to the side rails. More specifically, a machined stainless steel leg bolt 9 that has been custom machined to have a threaded hole running through its center should be used. After the machined bolt is inserted into the hole in the side rail 6, it would be secured with a common lock washer and jam nut. This provides stainless steel threads with no fear of rust, corrosion, or stripping out. It might be noted that the lock washer and jam nut don't have to be stainless steel. They can still be typical carbon steel with zinc plating, helping keep the cost of materials down. For what it's worth, the hex head of the leg bolt 9 (FIG. 1A) is machined down to make sure there's clearance for the leg 8 (FIG. 1A) itself.

Again, the above describes the side rail leg securing assemblies 1100, 1101, 1102, 1103 and 1104 shown in FIGS. 11A-E.

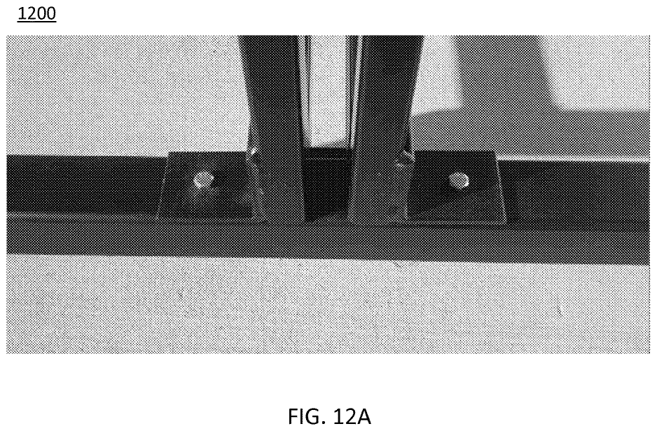

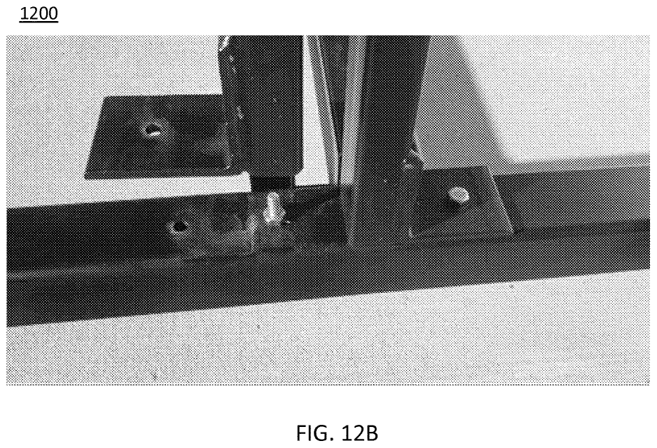

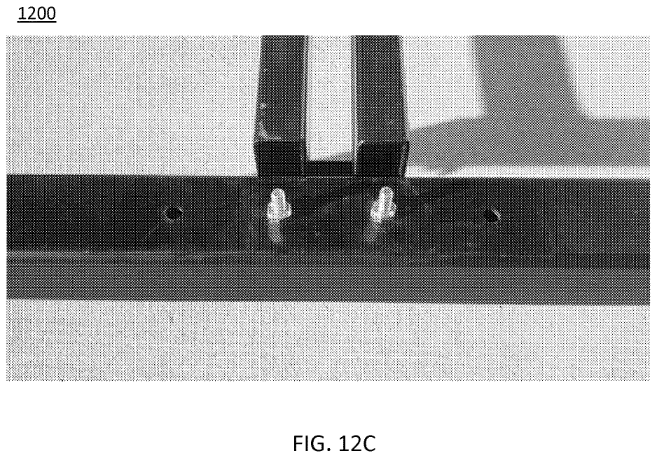

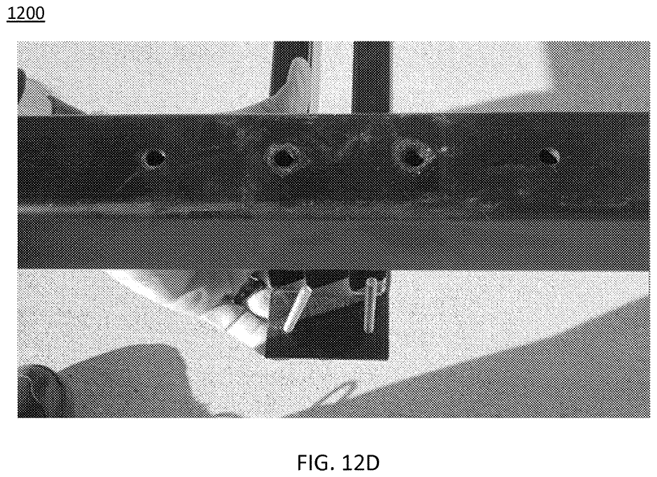

FIG. 12A shows a lower crossmember assembly/disassembly to the side rail 1200 according to an aspect of the present disclosure.

FIG. 12B shows another lower crossmember assembly/disassembly to the side rail 1201 according to an aspect of the present disclosure.

FIG. 12C shows another lower crossmember assembly/disassembly to the side rail 1202 according to an aspect of the present disclosure.

FIG. 12D shows another lower crossmember assembly/disassembly to the side rail 1203 according to an aspect of the present disclosure.

As shown in FIGS. 12A-D, and for lower crossmember assemblies/disassemblies to the side rail 1200, 1201, 1202, and 1203, the problem and the solution will now be described for the lower crossmember assembly to the side rail 1200. In addition, FIGS. 12A-D are not limited to a particular order and even though as ordered from FIG. 12A to FIG. 12D a disassembly of the lower crossmember is shown, another order these figures can be viewed in is from FIG. 12D to FIG. 12A showing an assembly of the lower crossmember.

Problem: the goal with assembling the lower crossmember 4 (FIG. 1A) is that the side rails 6 have to be aligned as “cleanly” as possible, providing an overall clean and simple look with respect to no components sticking out or looking unsightly. The sign frame 100 is a marketing tool. Ideally, you don't want to have too much in the way of unsightly bracketing. Plus, it would also add unneeded cost. Moreover, welding the lower crossmember 4 (FIG. 1A) to the side rails 6, although a clean solution, would defeat the purpose of the overall sign frame being collapsible, and significantly increase shipping costs to the end user.

Solution: the solution is to provide small flange, or foot, to the lower crossmember 4 ends. Then, have the bolt holes that would secure the lower crossmember 4 to the side rails 6 while lining up with the tubing of the upright components 7 (FIG. 1A). This allows the bolt and nut to hide inside of the upright component 7, becoming out of sight to the viewer of the sign frame. In other words, when the upright components 7 are assembled, they cover up the bolt used to assemble the lower crossmember 4. The result meets the goal of having a clean transition between the “Base Assembly” and the “Top Assembly” and making the overall sign frame look nicer and cleaner. This is all illustrated in FIGS. 12A-D as well.

The above has been described for lower crossmember assemblies/disassemblies to the side rail 1200, 1201, 1202, and 1203 shown in FIGS. 12A-D.

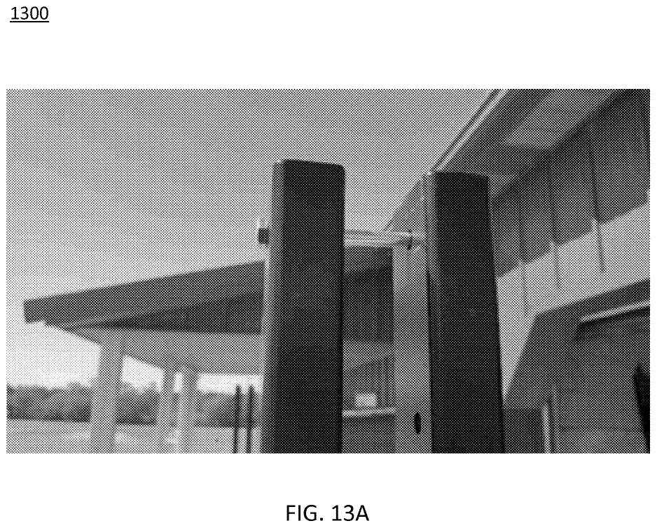

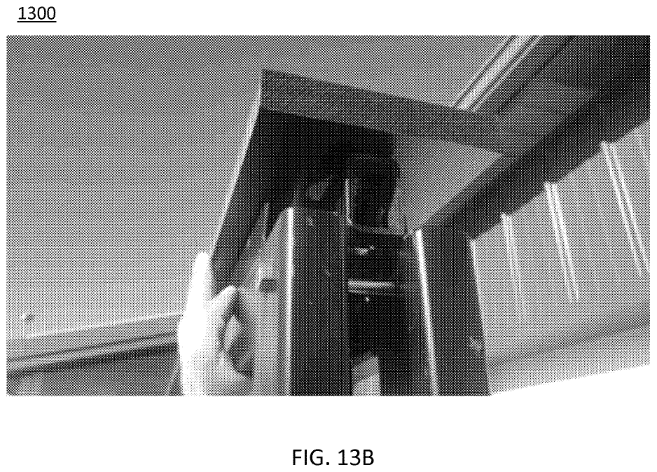

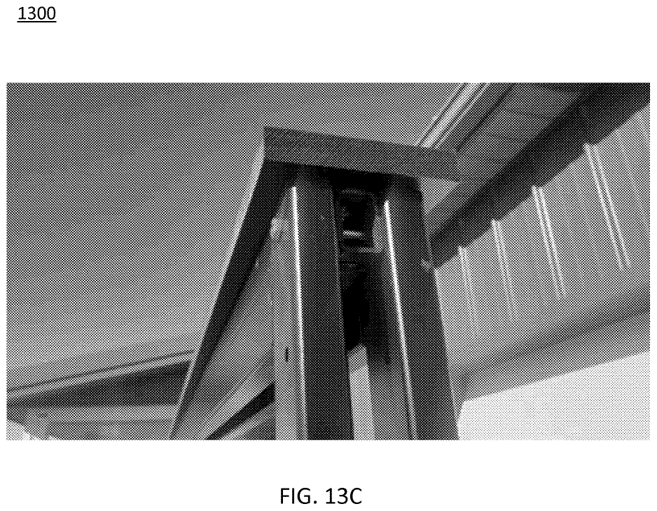

FIG. 13A shows a stage of a top crossbeam being assembled 1300 according to an aspect of the present disclosure.

FIG. 13B shows another stage of a top crossbeam being assembled 1301 according to an aspect of the present disclosure.

FIG. 13C shows another stage of a top crossbeam being assembled 1302 according to an aspect of the present disclosure.

Although FIGS. 13A-C may only show stages of a top crossbeam being assembled 1300, 1301 and 1302, the same process can be applied to assemble a middle crossbeam. In the context of the present disclosure, crossmember or crossmembers is synonymous with crossbeam or crossbeams.

As shown in FIGS. 13A-C, and stages of a top crossbeam being assembled 1300, 1301, and 1302, the problem and the solution will now be described for the assembly of the middle and top crossbeams shown in stages 1300, 1301, and 1302.

Problem: the goal here is to have the middle crossbeam 3 (FIG. 1A) and upper crossbeam 1 (FIG. 1A) assemble to the upright components 7 (FIG. 1A) as easily as possible. And since these crossbeams aren't light, and they're likely made of steel, safety is an important factor. The obvious method to mount these crossmembers is to have mating bolt holes to the upright components 7. Speaking from experience, this doesn't work very well.

For the middle crossbeam 3, trying to stab a bolt through the upright components 7 and crossbeam bolt holes with one person is somewhat difficult. A single person can only install one bolt at a time. To assemble the first bolt, it's difficult to hold the middle crossmember 3 in one hand, while keeping it horizontal enough to get the bolt hole in line with that of the upright component 7.

For the upper crossbeam 1, and for one person to install it, they'd have to set the whole “Upper Crossbeam Assembly” (which includes the top cap) on top of the four loosely assembled upright components 7. Basically, it'd just be balancing up there until the bolts are installed. Plus, all the weight of the “Upper Crossbeam Assembly” would be on the underside of the top cap, which is likely made of plastic and assembled to the upper crossbeam 1 with relatively small diameter bolts. This isn't safe.

The immediate solution is to require two people to assemble the middle crossbeam 3 and upper crossbeam 1. However, designing it to allow one person to do the job, again easily and safely, would be ideal.

Solution: the solution is to put vertical slots at each end of the middle crossbeam 3 and upper crossbeam 1. Doing so allows the bolts to be pre-assembled into the upright components 7. This creates a bridge in which the crossbeams can safely hang until the fasteners are tightened. An added benefit is that assembly is not only easier and safer, it's significantly faster.

Again, the above has been described for stages of a top (or middle) crossbeam being assembled 1300, 1301, and 1302, as shown in FIGS. 13A-C.

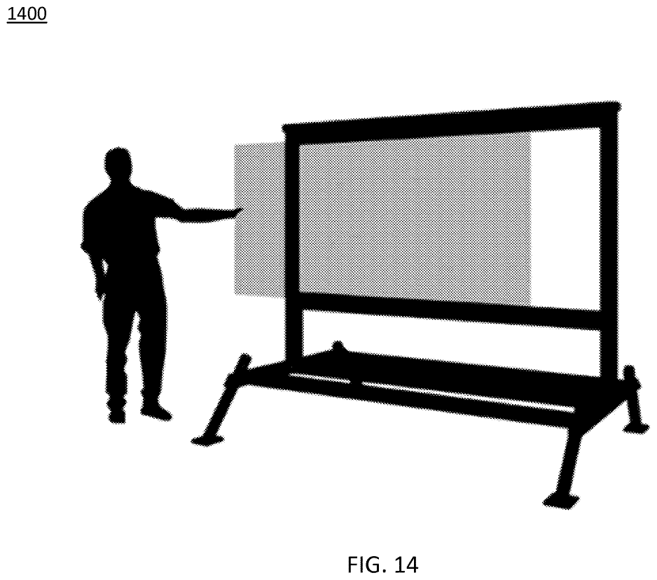

FIG. 14 shows an exemplary sign frame 1400 in use according to an aspect of the present disclosure. As can be seen by the exemplary sign frame 1400 in FIG. 14, a banner panel can be conveniently slid into the sign frame.

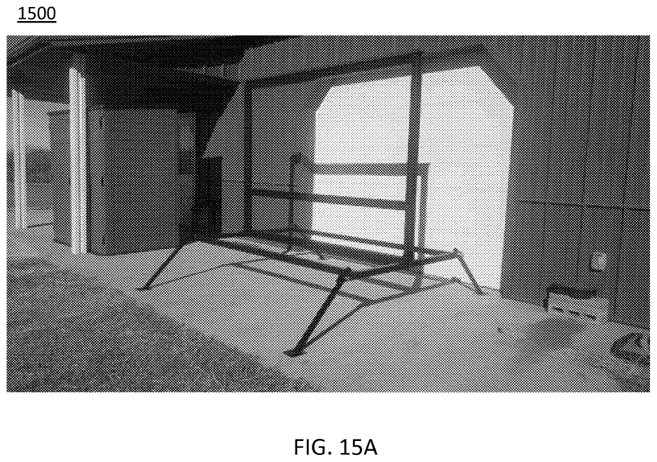

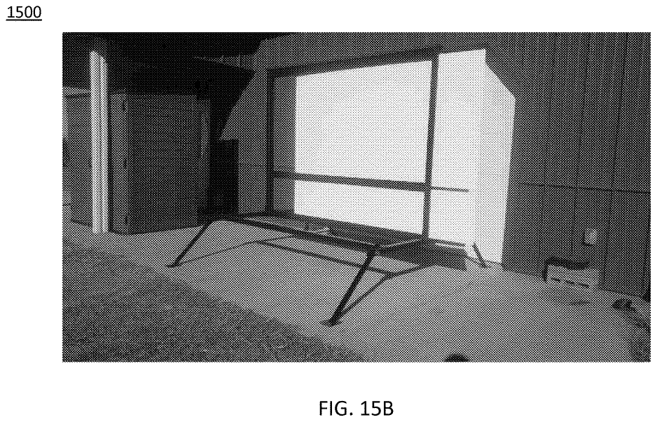

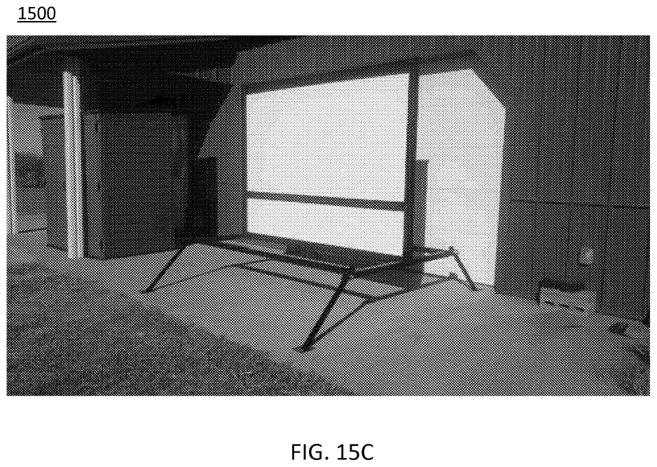

FIG. 15A shows an exemplary sign in use in front of a barn 1500 according to an aspect of the present disclosure.

FIG. 15B shows another exemplary sign in use in front of a barn 1501 according to an aspect of the present disclosure.

FIG. 15C shows another exemplary sign in use in front of a barn 1502 according to an aspect of the present disclosure.

As can be seen by the exemplary sign frames 1500, 1501, and 1502 in FIGS. 15A-C, the sign frames can be adjusted accordingly and placed in front of a barn or other similar building.

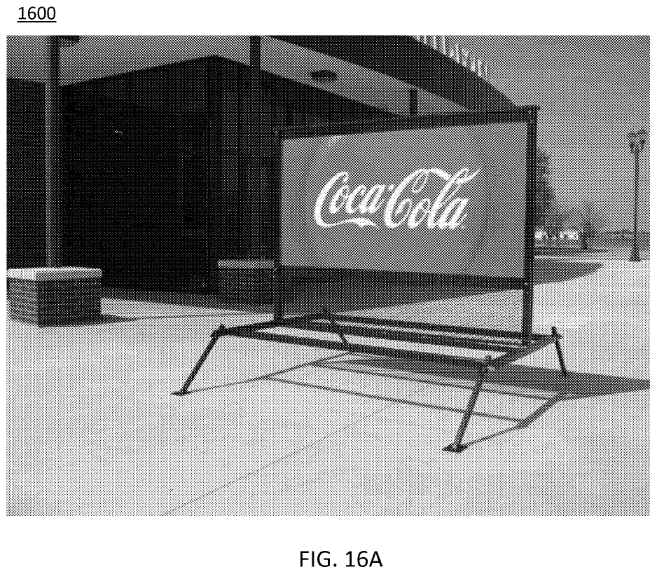

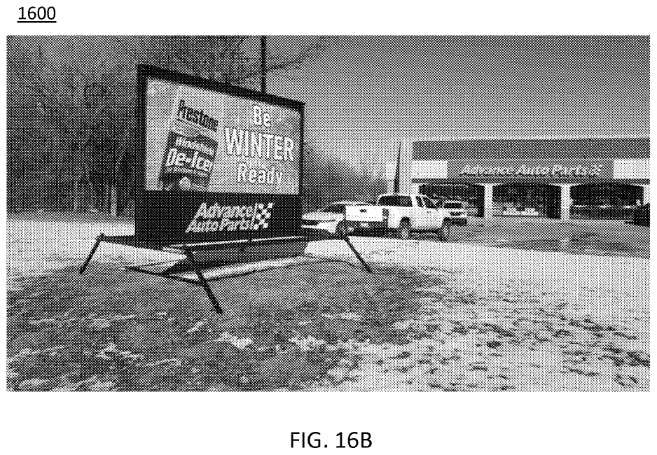

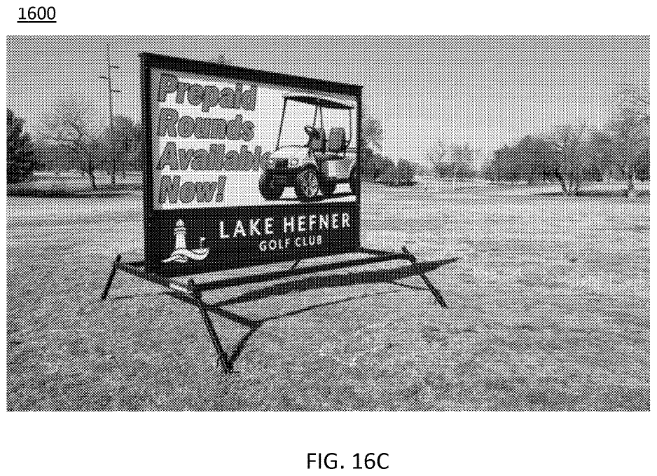

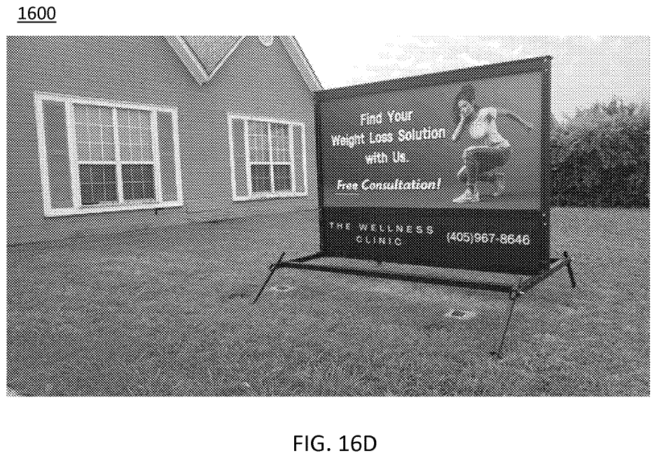

FIG. 16A shows an exemplary sign in use in outdoor environments 1600 according to an aspect of the present disclosure.

FIG. 16B shows another exemplary sign in use in outdoor environments 1601 according to an aspect of the present disclosure.

FIG. 16C shows another exemplary sign in use in outdoor environments 1602 according to an aspect of the present disclosure.

FIG. 16D shows another exemplary sign in use in outdoor environments 1603 according to an aspect of the present disclosure.

FIGS. 16A-D show exemplary sign frames 1600, 1601, 1602, and 1603 in use in outdoor environments according to an aspect of the present disclosure. As can be seen by the exemplary sign frames 1600, 1601, 1602, and 1603 in FIGS. 16A-D, the sign frames 1600, 1601, 1602, and 1603 can be placed in a variety of outdoor environments including in front of stores, homes, and public events, on lawns with organized grass, wild grass, artificial grass like astroturf, concrete, beaches, decks of ships (made of wood or metal) or buoys in a variety of weather conditions (e.g., sunny, snow, rain, etc.).

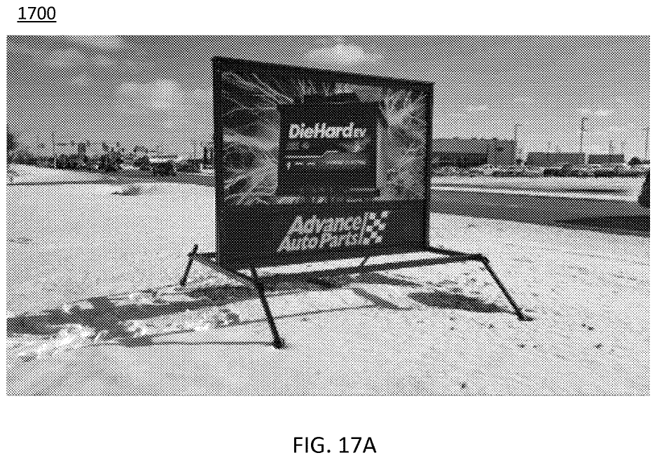

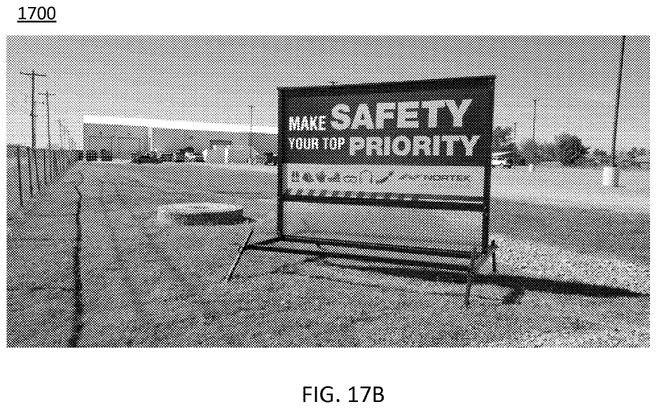

FIG. 17A shows an exemplary sign in use in outdoor environments with adverse weather conditions 1700 according to an aspect of the present disclosure.

FIG. 17B shows another exemplary sign in use in outdoor environments with adverse weather conditions 1701 according to an aspect of the present disclosure.

FIGS. 17A-B show exemplary sign frames 1700 and 1701 in use in outdoor environments with adverse weather conditions to an aspect of the present disclosure. As can be seen by the exemplary sign frames 1700 and 1701 in FIGS. 17A-B, the sign frames 1700 and 1701 can be placed in a variety of outdoor environments including in front of stores, factories, homes, and public events, on lawns with organized grass, wild grass, artificial grass like astroturf, concrete, beaches, decks of ships (made of wood or metal), or buoys in a variety of extreme weather conditions (e.g., very snowy or very sunny and dry or hot).

The sign frame invention is a collapsible and adjustable frame designed to securely hold banner panels for outdoor advertising. Its key features, benefits and advantages include:

Sturdy Construction—The sign frame is made of durable materials like steel, aluminum or plastic, ensuring stability and resistance to wind forces.

Side-Loading Capability—The frame allows for easy installation of banner panels by sliding them in from either side, with retaining bolts provided for additional security.

Adjustable Legs—The sign frame has legs that can be independently adjusted, enabling leveling on uneven surfaces and expanding the footing for enhanced stability.

Double-Sided Design—The frame is double-sided, offering two sets of viewports facing opposite directions for maximum visibility.

Optional Decorative Elements—The top cap of the sign frame serves both a decorative and functional purpose, allowing for the attachment of light fixtures and potential solar panels. The light fixtures may be easily mounted to the top cap, and the light fixtures include a solar light fixture, a solar panel, a solar panel coupled to a light fixture, a light fixture with a design, a decorative item coupled to the light fixture and similar objects.

The key benefits of the sign frame invention include:

Longevity and Professionalism-By addressing the problem of sagging and unreadable banners, the sign frame ensures that banner messages remain professional and readable for an extended period.

Cost-Effectiveness—The sign frame allows businesses and organizations to utilize banners for outdoor advertising without the need for frequent replacements, saving time and money.

Ease of Assembly and Transportation—The collapsible design of the sign frame allows for easy disassembly, storage, and transportation, making it convenient for businesses that require mobility or periodic setup changes.

Customizability—The sign frame can be tailored to different sizes and materials of banner panels, providing flexibility to meet the specific requirements and preferences of users.

The sign frame invention is a collapsible and adjustable frame designed to securely hold banner panels for outdoor advertising. Although, it should be mentioned, the sign frame could just as easily be used indoors, as well. This detailed description includes the construction, components, and unique aspects of the invention:

1. Construction:
The sign frame is primarily made of sturdy materials such as steel, aluminum or plastic to ensure durability and stability.
The frame consists of vertical uprights, horizontal crossmembers, side rails, front rails, and legs that are all assembled to create a rigid structure.
The top cap, typically made of plastic, but also possibly made from steel, serves both a decorative and functional purpose, allowing for the attachment of light fixtures and potential solar panels. The light fixtures may be easily mounted to the top cap, and the light fixtures include a solar light fixture, a solar panel, a solar panel coupled to a light fixture, a light fixture with a design, a decorative item coupled to the light fixture and similar objects.

2. Components:
Vertical Uprights: These vertical members provide bolting points for the crossmembers and retain the ends of the banner panels when installed.
Horizontal Crossmembers: The top crossmember features a channel that retains the top of the banner panels, while the middle crossmember retains the bottom of the top banner panels and the top of the bottom banner panels. The middle crossmember is removable, allowing for increased panel dimensions. The lower crossmember retains the bottom of the bottom banner panels.
Side Rails: These rails extend from the lower crossmember to space the legs out into the four corners, providing stability and structural support.
Pedestrian Barriers (or Front Rails): These pedestrian barriers (or front rails) connect the side rails near the leg positions, adding strength to the sign frame and additional weight to the base for stability.
Legs: Four legs slide in and out of the ends of the side rails, which have cutouts, at a 45-degree angle-specifically, the shafts of the legs are at a 45 degree angle and go through the cutouts-shown in FIGS. 11C-E. Although, this could be a different angle, as well in between the ranges of 20-60 degrees. These legs and the side rails allow for leveling on uneven surfaces and expand the footing of the sign frame as it is assembled higher, enhancing stability. The cutouts can be shaped in configurations including rectangular, square, circular, elliptical, hexagonal, pentagonal, heptagonal, octagonal and any other multi-sided shape.

3. Operation:
Banner panel installation: The banner panels are installed by sliding them into the frame from either side. The vertical and horizontal members retain the panels and keep them in place. Retaining bolts are provided in the vertical members to prevent movement in a side-to-side direction.
Adjustable legs: The legs can be independently adjusted to level the sign frame on uneven surfaces. This ensures a professional and visually appealing display of the banner panels.
Collapsible design: The components of the sign frame disassemble into straight members, allowing for easy storage, transportation, and a small footprint when not in use.

4. Unique Aspects and Innovations:
Side-loading capability: The side-loading feature of the sign frame simplifies the installation process, making it quick and efficient (see illustration on the final page).
Adjustable legs: The ability to adjust the legs independently allows for leveling on uneven surfaces, ensuring a professional appearance even on challenging terrains.
Double-sided design: The sign frame is designed to be double-sided, allowing for two sets of viewports facing opposite directions, maximizing visibility and impact.
Optional decorative elements: The top cap serves a dual purpose, providing a decorative element while also allowing for the attachment of light fixtures and potential solar panels. The light fixtures may be easily mounted to the top cap, and the light fixtures include a solar light fixture, a solar panel, a solar panel coupled to a light fixture, a light fixture with a design, a decorative item coupled to the light fixture and similar objects.

Overall, the sign frame invention offers a sturdy and versatile solution for securely displaying banner panels outdoors. Its unique features and innovations enhance stability, ease of installation, and customization options, providing longevity and professionalism to outdoor advertising campaigns.

Drawings or Diagrams:

Here is a visual of the sign frame invention, with a list of the components and their functions:

1. Top Cap (quantity per each sign frame is 1):
The top cap serves both a decorative and functional purpose. It can accommodate the attachment of light fixtures and potential solar panels, enhancing the versatility of the sign frame. The light fixtures may be easily mounted to the top cap, and the light fixtures include a solar light fixture, a solar panel, a solar panel coupled to a light fixture, a light fixture with a design, a decorative item coupled to the light fixture and similar objects.

2. Top Crossmember (quantity per each sign frame is 1):
This horizontal member features a channel that retains the top of the banner panels, keeping them securely in place.

3. Middle Crossmember (quantity per each sign frame is 1):
This horizontal member retains the bottom of the top banner panels and the top of the bottom banner panels. It is removable, allowing for increased panel dimensions.

4. Lower Crossmember (quantity per each sign frame is 1):
This horizontal member retains the bottom of the bottom banner panel. This member also provides structural support and weight to the base for stability.

5. Vertical Uprights (quantity per each sign frame is 4):
These vertical members serve as the primary support for the sign frame viewports. They provide bolting points for the crossmembers, and retain the ends of the banner panels when installed.

6. Side Rails (quantity per each sign frame is 2):
These rails extend from the lower crossmember to space the legs out into the four corners. They provide stability and structural support to the sign frame.

7. Pedestrian Barriers (or Front Rails) (quantity per each sign frame is 2):
These rails connect the side rails near the leg positions, adding strength to the sign frame and additional weight to the base for stability.

8. Legs (quantity per each sign frame is 4):
The legs slide in and out of the ends of the side rails at an angle between 30-60 degrees, e.g., a 45 degree angle, +/−15 degrees. They provide stability and support to the sign frame.

9. Leg Adjustment Mechanisms (quantity per each sign frame is 4):
These mechanisms allow for the independent adjustment of each leg to level the sign frame on uneven surfaces. What's used is a larger bolt made from corrosion resistant material. This bolt is secured in place with a nut and lock washer that doesn't necessarily need to be from corrosion resistant material. Once in place, a drilled and tapped hole in the larger bolt allows for a smaller bolt to be screwed through it, and secure the individual legs in place.

Processors, implemented by integrated circuits and semiconductors, may be utilized in the banners or the signs themselves for light emitting diode (LED) and electronic-based displays and similar functionality. A or several processors may be utilized in connection with various apparatuses and methods. These processors may be implemented using electronic hardware, computer software, or any combination thereof. Whether such processors are implemented as hardware or software will depend upon the particular application and overall design constraints imposed on the system. By way of example, a processor, any portion of a processor, or any combination of processors presented in this disclosure may be implemented with a microprocessor, microcontroller, digital signal processor (DSP), a field-programmable gate array (FPGA), a programmable logic device (PLD), a state machine, gated logic, discrete hardware circuits, and other suitable processing components configured to perform the various functions described throughout this disclosure. The functionality of a processor, any portion of a processor, or any combination of processors presented in this disclosure may be implemented with software being executed by a microprocessor, microcontroller, DSP, or other suitable platform.

Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. The software may reside on a computer-readable medium. A computer-readable medium may include, by way of example, memory such as a magnetic storage device (e.g., hard disk, floppy disk, magnetic strip), an optical disk (e.g., compact disc (CD), digital versatile disc (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, or a removable disk. Although memory is shown separate from the processors in the various aspects presented throughout this disclosure, the memory may be internal to the processors (e.g., cache or register).

Computer-readable media may be embodied in a computer-program product. By way of example, a computer-program product may include a computer-readable medium in packaging materials. Those skilled in the art will recognize how best to implement the described functionality presented throughout this disclosure depending on the particular application and the overall design constraints imposed on the overall system.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

For a firmware and/or software implementation, the methodologies may be implemented with modules (e.g., procedures, functions, and so on) that perform the functions described herein. A machine-readable medium tangibly embodying instructions may be used in implementing the methodologies described herein. For example, software codes may be stored in a memory and executed by a processor unit. Memory may be implemented within the processor unit or external to the processor unit. As used herein, the term “memory” refers to types of long term, short term, volatile, nonvolatile, or other memory and is not to be limited to a particular type of memory or number of memories, or type of media upon which memory is stored.

If implemented in firmware and/or software, the functions may be stored as one or more instructions or code on a computer-readable medium. Examples include computer-readable media encoded with a data structure and computer-readable media encoded with a computer program. Computer-readable media includes physical computer storage media. A storage medium may be an available medium that can be accessed by a computer. By way of example, and not limitation, such computer-readable media can include RAM, ROM, EEPROM, CD-ROM or other optical disk storage, magnetic disk storage or other magnetic storage devices, or other medium that can be used to store desired program code in the form of instructions or data structures and that can be accessed by a computer; disk and disc, as used herein, includes compact disc (CD), laser disc, optical disc, digital versatile disc (DVD), floppy disk and Blu-ray disc where disks usually reproduce data magnetically, while discs reproduce data optically with lasers. Combinations of the above should also be included within the scope of computer-readable media.

In addition to storage on computer readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the technology of the disclosure as defined by the appended claims. For example, relational terms, such as “above” and “below” are used with respect to a substrate or electronic device. Of course, if the substrate or electronic device is inverted, above becomes below, and vice versa. Additionally, if oriented sideways, above and below may refer to sides of a substrate or electronic device. Moreover, the scope of the present application is not intended to be limited to the particular configurations of the process, machine, manufacture, composition of matter, means, methods and steps described in the specification. As one of ordinary skill in the art will readily appreciate from the disclosure, processes, machines, manufacture, compositions of matter, means, methods, or steps, presently existing or later to be developed that perform substantially the same function or achieve substantially the same result as the corresponding configurations described herein may be utilized according to the present disclosure. Accordingly, the appended claims are intended to include within their scope such processes, machines, manufacture, compositions of matter, means, methods, or steps.

What is claimed is:

1. A collapsible sign frame, comprising
an upper crossbeam;
a top cap assembled to a top surface of the upper crossbeam;
a middle crossbeam;
a lower crossbeam;
at least one side rail comprising:
at least one cutout;
a top surface;
a bottom surface assembled to a foot of the lower crossbeam; and
hardware used to assemble the lower crossbeam to the at least one side rail;
an upright component assembled to the upper crossbeam, the middle crossbeam and the top surface of the at least one side rail;
at least one leg assembled through the at least one cutout of the at least one side rail; and
at least one leg securing set securing the at least one leg to the at least one side rail.

2. The collapsible sign frame of claim 1, wherein the upper crossbeam, the middle crossbeam, the lower crossbeam, the at least one side rail, and the at least one leg are made up of materials comprising steel, aluminum and plastic.

3. The collapsible sign frame of claim 1, wherein the top cap is made of UV light resistant materials comprising high-density polyethylene (HDPE), acrylic, Ultem®, Polyvinylidene Fluoride (PVDF), and Polytetrafluoroethylene (PTFE), and further wherein light fixtures may be easily mounted to the top cap, and even further wherein the light fixtures comprise a solar light fixture, a solar panel, a solar panel coupled to a light fixture, a light fixture with a design, a decorative item coupled to the light fixture and similar objects.

4. The collapsible sign frame of claim 1, wherein the at least one leg slides in the at least one cutout of the at least one side rail at an angle, which can be adjusted to provide stability on uneven surfaces for the collapsible sign frame.

5. The collapsible sign frame of claim 4, wherein the angle is selected from the range of 30 to 60 degrees.

6. The collapsible sign frame of claim 1, wherein the at least one cutout is shaped in configurations including rectangular, square, circular, elliptical, hexagonal, pentagonal, heptagonal, octagonal and any other multi-sided shape.

7. The collapsible sign frame of claim 1, wherein the upright component is assembled to the top surface of the at least one side rail by securing a bolt and a nut with the upright component and the at least one side rail, and further wherein the upright component covers the hardware used to assemble the lower crossbeam to the at least one side rail to provide a cleaner look.

8. The collapsible sign frame of claim 1, wherein the at least one leg securing set comprises:
a leg bolt;
a lock washer; and
a jam nut, wherein the jam nut secures the leg bolt to the at least one side rail with assistance of the lock washer.

9. The collapsible sign frame of claim 1, wherein the upright component assembled to the upper crossbeam and the middle crossbeam comprises fitting pre-assembled bolts of the upright component in at least one vertical slot of the upper crossbeam and the middle crossbeam to create a bridge where the upper crossbeam and the middle crossbeam can safely hang until the pre-assembled bolts are tightened.

10. The collapsible sign frame of claim 1, further comprising a pedestrian barrier to protect the safety of pedestrians by preventing pedestrians from walking into unsafe components of the collapsible sign frame such as the at least one side rail and the at least one leg that might unexpectedly jut out and cause the pedestrians to trip, wherein the pedestrian barrier is made up of materials comprising steel, aluminum and plastic.

11. A method for assembling a collapsible sign frame comprising:
assembling a base assembly comprising a lower crossbeam, at least one side rail, at least one leg and at least one leg securing set;
assembling a top assembly comprising at least one upright component, a middle crossbeam, an upper crossbeam, and a top cap; and
installing a banner panel.

12. The method for assembling a collapsible sign frame of claim 11, wherein assembling the base assembly comprises:
coupling the at least one leg to the at least one side rail by using the at least one leg securing set, the at least one leg securing set coupled to both the at least one leg and the at least one side rail;
tightly securing the at least one leg to the at least one side rail by tightening the at least one leg securing set.

13. The method for assembling a collapsible sign frame of claim 12, wherein the at least one leg securing set comprises at least one leg bolt, at least one lock washer and at least one jam nut, and further wherein assembling the base assembly further comprises:
securing the at least one leg, the at least one side rail, the at least one leg bolt, the at least one lock washer and the at least one jam nut all together; and
tightening the at least one leg, the at least one side rail, the at least one leg bolt, the at least one lock washer and the at least one jam nut all together.

14. The method for assembling a collapsible sign frame of claim 13, wherein assembling the base assembly further comprises:
fitting the at least one leg into at least one cutout of the at least one side rail at an angle; and
tightly securing the at least one leg with the at least one leg bolt, the at least one lock washer and the at least one jam nut through the at least one cutout.

15. The method for assembling a collapsible sign frame of claim 14, wherein the angle is selected from the range of 30 to 60 degrees and can be adjusted to provide stability for the collapsible sign frame on an uneven surface.

16. The method for assembling a collapsible sign frame of claim 14, wherein the at least one cutout is shaped in configurations including rectangular, square, circular, elliptical, hexagonal, pentagonal, heptagonal, octagonal and any other multi-sided shape.

17. The method for assembling a collapsible sign frame of claim 11, wherein assembling the base assembly further comprises:
installing the lower crossbeam to the at least one side rail using a first set of common bolts and nuts;
leveling out the lower crossbeam and the at least one side rail by adjusting the at least one leg; and
securely tightening the first set of common bolts and nuts across the lower crossbeam and the at least one side rail.

18. The method for assembling a collapsible sign frame of claim 17, wherein assembling the base assembly further comprises:
installing at least one pedestrian barrier to the at least one side rail using a second set common bolts and nuts;
leveling out the lower crossbeam, the at least one side rail and the at least one pedestrian barrier by adjusting the at least one leg; and
securely tightening the second set of common bolts and nuts across the lower crossbeam, the at least one side rail and the at least one pedestrian barrier.

19. The method for assembling a collapsible sign frame of claim 11, wherein assembling the top assembly comprises:
coupling the upper crossbeam and the top cap with a first set of common bolts and nuts and securing the upper crossbeam and the top cap with the first set of common bolts and nuts;
installing the at least one upright component to the at least one siderail by using a second set of common bolts and nuts and loosely securing the at least one upright component and the at least one siderail with the second set of common bolts and nuts;
installing a third set of common bolts and nuts and a fourth set of common bolts and nuts that are coupled to the at least one upright component;
hanging the middle crossbeam on the third set of common bolts and nuts;
loosely securing the third set of common bolts and nuts on the at least one upright component;
hanging the upper crossbeam on the fourth set of common bolts and nuts;
loosely securing the fourth set of common bolts and nuts on the at least one upright component; and
tightening all the first, second, third and fourth sets of common bolts and nuts to secure the top assembly.

20. The method for assembling a collapsible sign frame of claim 11, wherein installing the banner panel comprises:
sliding a banner panel in between or propped up against the at least one upright component; and
installing a first set of common bolts and nuts with the at least one upright component to retain the banner panel that is slid in.
